(19) United States
(12) Patent Application Publication
(10) Pub. No.: US 2005/0268343 A1
(43) Pub. Date: Dec. 1, 2005

(54) Application management device and its method

(76) Inventors: Sen'ichi Onoda, Toyonaka-shi (JP); Masaya Yamamoto, Hirakata-shi (JP); Akio Higashi, Toyonaka-shi (JP); Ryuichi Okamoto, Kadoma-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/126,155

(22) Filed: May 11, 2005

(30) Foreign Application Priority Data
May 14, 2004 (JP) 2004-145548

(51) Int. Cl. H04L 9/00

(52) U.S. Cl. 726/26

(57) ABSTRACT

An application management device 54 that is capable of judging the necessity of application deletion with little load includes: a DRM application DB 520 that stores plural applications in association with their respective identification information (DRM application IDs) for identifying a correspondence between a license and an application for processing such license; and a DRM application deletion judgment unit 527 that judges, for each of the applications stored in the DRM application DB 520, whether deletion of an application is necessary or not, based on the identification information. More specifically, the application management device 54 further includes a license DB 521 for storing each license in association with the identification information, and the DRM application deletion judgment unit 527 judges that an application whose license associated with the identification information is not stored in the license DB 521, is an application to be deleted.

### BACKGROUND OF THE INVENTION

(1) Field of the Invention

The present invention relates to an application management device and its method for managing an application that is intended for processing a license corresponding to a content, and particularly to an application management device and its method that are suited for a terminal device that constitutes a content distribution system.

(2) Description of the Related Art

In recent years, a system referred to as a content distribution system has come into practical use. A content distribution system is a system in which a digital work such as music, video, and game (such a digital work is hereinafter also described as a “content”) is distributed from a server device to a terminal device through a communication network such as the Internet or through a digital broadcasting or the like, and in which it is possible to use the content by the terminal device.

A general content distribution system employs Digital Rights Management (DRM) in order to protect the copyright of a content and to prevent unauthorized use of the content by a malicious user or the like. More specifically, the DRM is a technology for securely controlling the user's use of a content through use of cryptography or the like, such as the reproduction of the content and the copying of the content onto a storage medium.

Conventional content distribution systems include a system in which: a server device generates a license that includes a partial usage rule such as the number of reproductions for which a terminal device is permitted to use a content, and distributes the generated license to the terminal device; the terminal device controls use of the content based on logical sum or logical product of the partial usage rule (for example, see Japanese Laid-Open Patent application No. 2000-293439, pp. 1 to 29, FIG. 1). In the following, such a method as achieves the copyright protection of a content using DRM is referred to as a rights management method.

The conventional content distribution systems have problems such as below.

The first problem is that there is no method available for controlling the use of a content by a terminal device by using, in a single content distribution system, plural rights management methods that coexist or that are in coordination with each other. More specifically, a method is unknown for controlling the use of a content by the terminal device through a coordinated use of a rights management method A developed by a manufacturer α and a rights management method B developed by a manufacturer β in a service provided by a service provider δ operating a content distribution system. In other words, the conventional rights management methods are subject to the assumption that there exists only one type of rights management method in a single system, meaning that they do not function in an environment where there exists a mixture of plural different rights management methods. Here, “different rights management methods” indicates more specifically that there are differences in the following: usage rule information indicating details about the right to use a content; physical data structure of license information (data length, data array, and encryption method, or the like); and methods for interpreting the usage rule information and the data structure (representation format, how bit patterns and their meanings are associated, or the like).

The second problem is that, in order to expand the current scope of content use control in a terminal device, it is necessary to modify the functions of two processing units in such terminal device, that is, a license interpretation unit that interprets a license and a use permitability judgment unit that judges whether to permit the use of a content or not. More specifically, in order to add a control for controlling the length of time for using a content (hereinafter referred to as “use time”) to a rights management method that controls the number of content uses, it is necessary to add, to the license interpretation unit, a function of interpreting use time and to add, to the use permitability judgment unit, a function of judging whether to permit the use of the content or not based on the use time. In other words, the conventional rights management methods require addition and modification of the functions of many processing units included in the terminal device in order to expand the scope of content use control. However, since it is substantially difficult to expand the scope of content use control, the conventional rights management methods have a problem that they have poor expandability.

To be more specific, in order to be able to securely control the use of a content based on a partial usage rule included in a license received from a server, the terminal device includes the following as one package: a receiving unit that receives a license from the server; a storage unit that stores the received license; a reproduction unit that generates, from the content, data to be reproduced based on the partial usage rule included in the license; or the like. For this reason, in order to implement a rights management method S1 developed by a manufacturer M1 and a rights management method S2 developed by a manufacturer M2 in the server and the terminal device, when using a service provided by a service provider P operating a content distribution system, such server and terminal device are each required to be equipped with a processing unit that supports the rights management method S1 and a processing unit that supports the rights management method S2. Since plural processing units that perform the same processing exist in the same device, it is wasteful and results in a heavy load at implementation time.

In view of the above, a conceivable content use management system that solves the above problems is one that is capable of controlling the use of a content by a terminal device based on plural rights managements method and that has flexibility and expandability such that there is no need to modify the function of the use permitability judgment unit in order to expand the scope of the use control in the terminal device.

In other words, in order to implement the rights management method S1 developed by the manufacturer M1 and the rights management method S2 developed by the manufacturer M2 in the server and the terminal device, when using a service provided by the service provider P operating a content distribution system, such server and terminal device are each required to be equipped with a program that supports the rights management method S1 and a program that supports the rights management method S2. Since it is programs that exist in each of the server and the terminal device, load that is generated at implementation time is alleviated.

In such a system as descried above, it is only required to obtain a license in order to use a content and to download a DRM application program (hereinafter also referred to as “DRM application”) that corresponds to the license in order to control such license. Furthermore, it is possible to support plural DRM methods by adding, one by one, necessary DRM applications to one device (e.g., IC card).

However, in the case where unnecessary DRM applications remain undeleted, a necessary DRM application cannot be added due to a limited storage capacity or the like. This makes a problem especially when the memory capacity is small such as that of an IC card.

As a general conventional technology for deleting an application, there is a capacity management device that includes: a capacity management unit that manages a free space of an information storage device storing application programs and a threshold related to a predetermined free space; an application management unit that manages application information of each of the application programs stored in the information storage device, the application information including a total capacity and the last use date of files that constitute an application program stored in the information storage device; a detection unit that detects that the free space managed by the capacity management unit has fallen below the threshold; a selection unit that sequentially selects application programs whose last use date included in their respective application information managed by the application management unit is the oldest, in the case where the detection unit detects that the free space has fallen below the threshold, the selection being made until a sum of the total capacity in the application information of each of such application programs becomes greater than the difference between the threshold and the free space; and an application deletion unit that deletes, from the information storage device, the files that constitute each application program selected by the selection unit (for example, see Japanese-Laid Open Patent application No. 10-260873, pp. 1 to 21, FIG. 1).

According to this conventional technology, application management is associated with the free space of the information storage device such as a hard disk device. Such conventional technology achieves an efficient capacity management without bothering the user by detecting that the free space of the information storage device has fallen below a predetermined threshold and by automatically deleting an appropriate number of applications starting from an application whose last use date is the oldest of all.

However, a conventional application management device has a first problem that the detection of a free space results in a heavy load since, in order to make a judgment of whether deletion of an application is necessary or not, an accurate detection is required at all times to detect a free space which is time-variant information that changes momentarily.

Furthermore, a conventional application management device has a second problem that the deletion of an application consumes time due to the necessity to accurately detect a free space at all times.

### SUMMARY OF THE INVENTION

In view of the above, a first object of the present invention is to provide an application management device and its method that are capable of judging whether deletion of an application is necessary or not with little load.

A second object of the present invention is to provide an application management device and its method that are capable of deleting, in a short time, an application whose deletion is judged as being necessary.

In order to achieve the first object, the application management device according to the present invention is an application management device that manages applications, each of which is a program for processing a license corresponding to a content, the device including: an application storage unit that holds the applications, each of which is associated with identification information that identifies a correspondence between a license and the application for processing the license; and an application deletion judgment unit that judges, for each of the applications held by the application storage unit, whether deletion of an application is necessary or not, based on the identification information.

Accordingly, it becomes possible to make a significant reduction in load that is generated when making a judgment of whether deletion of an application is necessary or not, since such judgment is each made based on fixed, invariant information and identification information without using information about the free space which is time-variant information that changes momentarily, as has been done conventionally.

Furthermore, in order to achieve the second object, the application management device according to the present invention may further include an application deletion unit that deletes an application whose deletion is judged as being necessary by the application deletion judgment unit.

Accordingly, it becomes possible to reserve a free space in the application storage unit.

Moreover, the application management device according to the present invention may further include a first presentation unit that presents, to a user, the application deleted by the application deletion unit.

Accordingly, it becomes possible for the user to know a result of application deletion.

Furthermore, the application management device according to the present invention may further include a second presentation unit that presents, to the user, the application whose deletion is judged as being necessary by the application deletion judgment unit, wherein the application deletion unit may delete the application after receiving, from the user, an instruction to delete the application.

Accordingly, it becomes possible for the user to know in advance an application to be deleted.

Furthermore, the application management device according to the present invention may further include: a license storage unit that holds each license in association with the identification information; and a license deletion unit that deletes, from the license storage unit, a license whose use right has been exhausted, wherein the application deletion judgment unit may judge whether deletion of an application is necessary or not by being triggered by the deletion of the license performed by the license deletion unit.

Accordingly, it becomes possible to make a judgment of whether deletion of an application is necessary or not at appropriate timing.

Moreover, in the application management device according to the present invention, the application deletion judgment unit may judge whether deletion of an application is necessary or not by being triggered by at least one of the following operations performed by a user: a power-on operation and an operation for downloading an application.

Accordingly, it becomes possible to make a judgment of whether deletion of an application is necessary or not at appropriate timing.

Furthermore, in the application management device according to the present invention, the identification information may be at least one of an application ID unique to each application and a license ID unique to each license.

Moreover, the application management device according to the present invention may further include a license storage unit that holds each license in association with the identification information, wherein the application deletion judgment unit may judge that deletion of an application is necessary, the application being an application whose license associated with the identification information is not held by the license storage unit.

Accordingly, it becomes possible to make a significant reduction in load since a judgment of whether deletion of an application is necessary or not is made through extremely simple processing of judging whether or not a license associated with the identification information is stored in the license storage unit.

Furthermore, in the application management device according to the present invention, the application storage unit may hold information showing a use frequency of each application in association with the identification information, and the application deletion judgment unit may judge that deletion of an application whose use frequency is lowest is necessary.

Accordingly, it becomes possible to make a significant reduction load since a judgment of whether deletion of an application is necessary or not is made through extremely simple processing of detecting an application with the lowest use frequency among applications that are associated with their respective identification information.

Moreover, the application management device according to the present invention may further include an application deletion unit that deletes an application whose deletion is judged as being necessary by the application deletion judgment unit, wherein the application storage unit may hold, in association with the identification information, a first criterion for application deletion indicating presence or absence of each license and a second criterion for application deletion that is different from the first criterion, the application deletion judgment unit, in the case of judging that deletion of a plurality of applications is necessary, may determine an application to be deleted by narrowing down the plurality of applications to one application based on a combination of the first criterion and the second criterion, and the application deletion unit may delete the application determined by the application deletion judgment unit.

Accordingly, even when there are plural applications whose deletion is judged as being necessary, it is possible to delete an optimum application through extremely simple processing of narrowing down to one application based on a combination of a criterion for application deletion indicating the presence or absence of a license and another criterion for application deletion, and further to make a significant reduction in load.

Furthermore, in the application management device according to the present invention, the second criterion may be a last use date that is a date on which each application was used last, and the application deletion unit may delete the plurality of applications starting from the application whose corresponding license is not present, the plurality of applications having an oldest last use date.

Moreover, in the application management device according to the present invention, the second criterion may be a use frequency of each application, and the application deletion unit may delete the plurality of applications starting from the application whose corresponding license is not present, the plurality of applications having a lowest use frequency.

Furthermore, in the application management device according to the present invention, the second criterion may be an expiration date of each application, and the application deletion unit may delete the plurality of applications starting from the application whose corresponding license is not present, the plurality of applications having an expired expiration date.

Note that not only is it possible to embody the present invention as an application management device as described above but also as an application management method that includes, as its steps, characteristic units included in the application management device, and as a program that causes a computer to execute such steps. It should be also noted that such program can be distributed on a recording medium such as a CD-ROM and over a transmission medium such as the Internet.

As is obvious from the above description, the application management device according to the present invention produces the effect of making a significant reduction in load that is generated when making a judgment of whether deletion of an application is necessary or not, since such judgment is made based on fixed, invariant information and identification information without using information about the free space which is time-variant information that changes momentarily, as has been done conventionally. Furthermore, since an application whose deletion is judged as being necessary is deleted, it is possible to reserve a free space in the application storage unit easily and in a short time. As a result, it is possible to reliably download a necessary application.

Thus, the present invention, which facilitates application management in an IC card or the like, provides a highly significant practical value in the present age that has seen the proliferation of content distribution in an environment where plural types of DRM methods coexist.

The disclosure of Japanese Patent Application No. 2004-145548 filed on May 14, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing an overall structure of a content use management system 1 to which an application management device of a first embodiment is applied;

FIG. 2 is a diagram showing a data structure of a content 70 shown in FIG. 1;

FIG. 3 is a diagram showing a data structure of a license 80 shown in FIG. 1;

FIG. 4 is a diagram showing a data structure of a DRM application 90 shown in FIG. 1;

FIG. 5 is a functional block diagram showing a detailed structure of a reproduction terminal shown in FIG. 1;

FIG. 6 is a diagram showing a data structure of data managed in a DRM application DB 520;

FIG. 7 is a diagram showing a data structure of data managed in a license DB 521;

FIG. 8 is a diagram showing procedures for overall processing performed among a secondary distributing device, a secondary destination device, and a DRM application distribution server;

FIG. 9 is a flowchart showing details of DRM application copying processing;

FIG. 10 is a diagram showing a sequence of the DRM application obtainment processing (S107) shown in FIG. 9;

FIG. 11 is a flowchart showing DRM application deletion processing performed between a reproduction control unit 51 and a DRM device 52 of a reproduction terminal 50;

FIG. 12 is a diagram showing another data structure of the data managed in the DRM application DB 520;

FIG. 13 is a flowchart showing another operation of the DRM application deletion processing performed between the reproduction control unit 51 and the DRM device 52 of the reproduction terminal 50;

FIG. 14 is a diagram showing further another data structure of the data managed in the DRM application DB 520; and

FIG. 15 is a diagram showing further another data structure of the data managed in the DRM application DB 520;

### DESCRIPTION OF THE PREFERRED EMBODIMENT

The following provides a detailed description of a preferred embodiment of the present invention with reference the drawings.

### First Embodiment

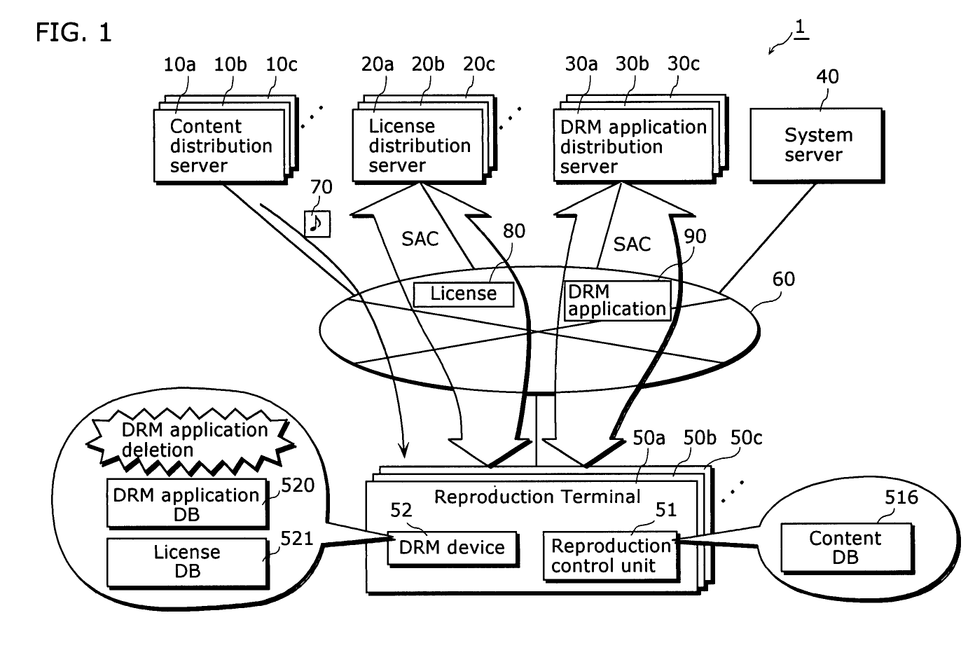

FIG. 1 is a diagram showing an overall structure of a content use management system 1 to which an application management device of the first embodiment is applied.

The content use management system 1 is a system in which a user uses a content by a reproduction terminal by using: a content distributed from a content distribution server via a transmission path; a license distributed from a license distribution server; and a DRM application distributed from a DRM application distribution server. Such content use management system 1 is comprised of plural content distribution servers 10a, 10b, 10c, . . . , plural license distribution servers 20a, 20b, 20c, . . . , plural DRM application distribution servers 30a, 30b, 30c, . . . , a system server 40, plural reproduction terminals 50a, 50b, 50c, . . . , and a wireless or wired transmission path 60 that enables them to communicate with each other.

Each of the content distribution servers 10a, 10b, 10c, . . . is a server device for distributing a content to the reproduction terminal 50a, 50b, 50c, . . . via the transmission path 60, and is implemented as a workstation or the like. More specifically, each of the content distribution servers 10a, 10b, 10c, . . . distributes a content that is digitally compressed using a compression method such as Moving Picture Expert Group (MPEG)-2 and MPEG-4 and that is encrypted, where necessary, using an encryption algorithm such as Advanced Encryption Standard (AES) and Triple Data Encryption Standard (DES).

For example, in the case of the Internet, each of the content distribution servers 10a, 10b, 10c, . . . can be a server device that streams a content using a protocol such as Realtime Transfer Protocol (RTP)/User Datagram Protocol (UDP) or can be a server device that provides a downloaded content using a protocol such as File Transfer Protocol (FTP) and Hypertext Transfer Protocol (HTTP).

Meanwhile, in the case of digital broadcasting, each of the content distribution servers 10a, 10b, 10c, . . . can be a device that provides a streaming content in the form of an MPEG-2 Transport Stream (TS) or can be a device that provides a storage-type content in compliant with a data carousel transmission method such as one described in Association of Radio Industries and Business (ARIB) STD-B24.

Note that the present embodiment assumes that the content distribution server 10a, 10b, 10c, . . . are server devices that provide downloaded contents.

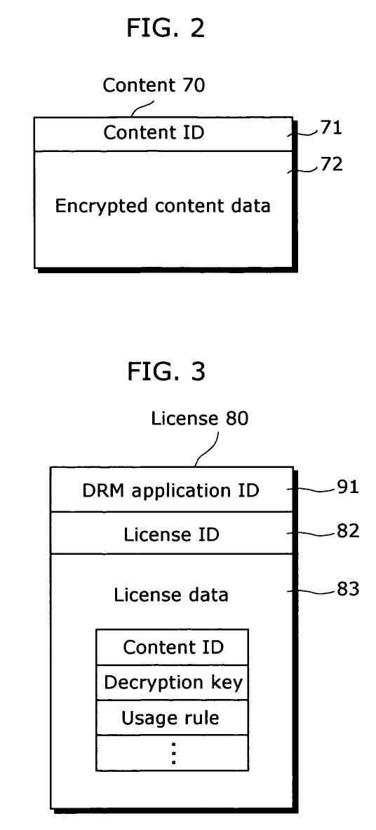

Referring to FIG. 2, a content 70 distributed from the content distribution server 10a, 10b, 10c, or . . . has a data structure made up of a content ID 71 and encrypted content data 72. An encryption algorithm generally used to obtain this encrypted content data 72 is a symmetric key algorithm such as AES and Triple DES.

Each of the license distribution servers 20a, 20b, 20c, . . . is a server device that manages the usage rule of a content owned by a user and grants a license to use the content to the user. More specifically, each of the license distribution servers 20a, 20b, 20c, . . . (1) manages the usage rules of contents owned by users or the reproduction terminals 50a, 50b, 50c, . . . on a per-user or per-reproduction terminal basis, for each rights management method, (2) generates a license upon request from a user, and (3) distributes, via the transmission path 60, the generated license to the requesting reproduction terminal 50a, 50b, 50c, or . . . . The present embodiment assumes the case where rights management to control the content use is carried out in a content distribution service as follows: the license distribution server 20a follows a rights management method A provided by a manufacturer α; the license distribution server 20b follows a rights management method B provided by a manufacturer β; and the license distribution server 20c follows a rights management method C provided by a manufacturer γ.

Referring to FIG. 3, a license 80 distributed from the license distribution server 20a, 20b, or 20c, . . . has a data structure made up of a DRM application ID 91 that uniquely identifies a DRM application for processing such license, a license ID 82 that uniquely identifies such license, and license data 83. The license data 83 is made up of the content ID of a content to which this license is applied, a decryption key (content key) for decrypting an encrypted content, and information related to the control of content use (usage rule(s)). Here, the usage rules include: the number of uses indicating the maximum number of times the content identified by the content ID is permitted to be used; use time indicating a total use time permitted for the content identified by the content ID; use expiration date indicating the date until when the content identified by the content ID is permitted to be used; or the like. Each manufacturer can set one of these or an arbitrary combination of these as usage rule(s).

Meanwhile, in the case where data such as a license is sent and received via the transmission path 60 between the license distribution server 20a, 20b, 20c, or . . . and the reproduction terminal 50a, 50b, 50c, or . . . , data transmission is performed after a secure authenticated channel (SAC) is established to ensure security.

Each of the DRM application distribution servers 30a, 30b, 30c, . . . is a server device that distributes, via the transmission path 60, a DRM application for processing a license owned by a user to the reproduction terminal 50a, 50b, 50c, or . . . whose user has requested the distribution. More specifically, each of the DRM application distribution servers 30a, 30b, 30c, . . . manages DRM applications on a per-rights management method basis, and distributes, via the transmission path 60, a DRM application to the requesting reproduction terminal 50a, 50b, 50c, or . . . whose user has requested the distribution. The present embodiment assumes the case where rights management to control the content use is carried out in the content distribution service as follows: the DRM application distribution server 30a follows the rights management method A provided by the manufacturer α; the DRM application distribution server 30b follows the rights management method B provided by the manufacturer β; and the DRM application distribution server 30c follows the rights management method C provided by the manufacturer γ.

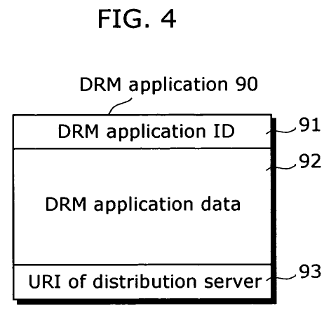

Referring to FIG. 4, a DRM application 90 distributed from the DRM application distribution server 30a, 30b, 30c, or . . . has a data structure made up of a DRM application ID 91 that uniquely identifies the DRM application, DRM application data 92 for processing a license, and a distribution server's uniform resource identifier (URI) 93 indicating a Web address of such DRM application. The DRM application 90 is associated with the license 80, with its DRM application ID as information to identify such DRM application 90 (hereinafter referred to as “identification information”). The DRM application 90 is a program that controls the use of a content under the usage rule(s) included in license data 83 and that deletes a license whose use right has been exhausted. In order to prevent hacking, an expiration date is set to the DRM application 90. Note that the present embodiment assumes that the DRM application 90 is associated with the license 80, with its DRM application ID as identification information, but the DRM application 90 may be associated with the license 80, with the license ID of such license 80 as identification information.

In the case where data such as a DRM application 90 is sent and received via the transmission path 60 between the DRM application distribution server 30a, 30b, 30c, or . . . and the reproduction terminal 50a, 50b, 50c, or . . . , data transmission is performed after a SAC is established to ensure security, as in the case of transmitting the license 80.

The system server 40 is a server device that notifies the reproduction terminal 50a, 50b, 50c, . . . of the following information via the transmission path 60 upon their requests: information in list form about contents provided in the system; the URI of the content distribution servers 10a, 10b, 10c, or . . . that provides a content the user wishes to obtain; the URI of the license distribution server 20a, 20b, 20c, or . . . that provides a license for such content; the URI of the DRM application distribution server 30a, 30b, 30c, or . . . that provides a DRM application for processing such license; or the like. In other words, the system server 40 serves as a general information desk in the content use management system 1.

The transmission path 60 is a communication path that mutually connects the content distribution servers 10a, 10b, 10c, . . . , the license distribution servers 20a, 20b, 20c, . . . , the DRM application distribution servers 30a, 30b, 30c, . . . , the system server 40, and the reproduction terminals 50a, 50b, 50c, . . . . An example of the transmission path 60 is a communication network (e.g., the Internet), a digital broadcasting, and a network that is implemented as a combination of these.

Each of the reproduction terminals 50a, 50b, 50c, . . . is a terminal device that has a function of being connected to the transmission path 60, and that is used by the user to use a content on its monitor screen, read a content onto a storage medium, and the like. More specifically, each of the reproduction terminals 50a, 50b, 50c, . . . is a content display device or a recorder such as set-top box (STB), a digital television, a digital versatile disc (DVD) recorder, a hard disk drive (HDD) recorder, a personal computer (PC), or a device that is implemented as a combination of these. Each of the reproduction terminals 50a, 50b, 50c, . . . includes a reproduction control unit 51 and a DRM device 52.

The reproduction control unit 51, which has a content DB 516 where contents 70 distributed from the content distribution servers 10a, 10b, 10c, . . . are stored and managed, decrypts an encrypted content and reproduces a decrypted content. The DRM device 52, which is a tamper-resistant module such as an IC card and an IC chip has: a DRM application DB 520 where DRM applications 90 distributed from the DRM application distribution servers 30a, 30b, 30c, . . . are stored and managed; and a license DB 521 where licenses 80 distributed from the license distribution servers 20a, 20b, 20c, . . . are stored and managed. When reproducing a content, the DRM device 52 launches a DRM application for processing the license for such content, passes the content key to the reproduction control unit 51, and controls the reproduction of the content within the scope of the usage rule(s). Furthermore, while the reproduction terminal 50a, 50b, 50c, or . . . is at power on time, the DRM device 52 judges whether a DRM application stored in the DRM application DB 520 is a necessary one or not, and deletes an unnecessary DRM application based on the judgment.

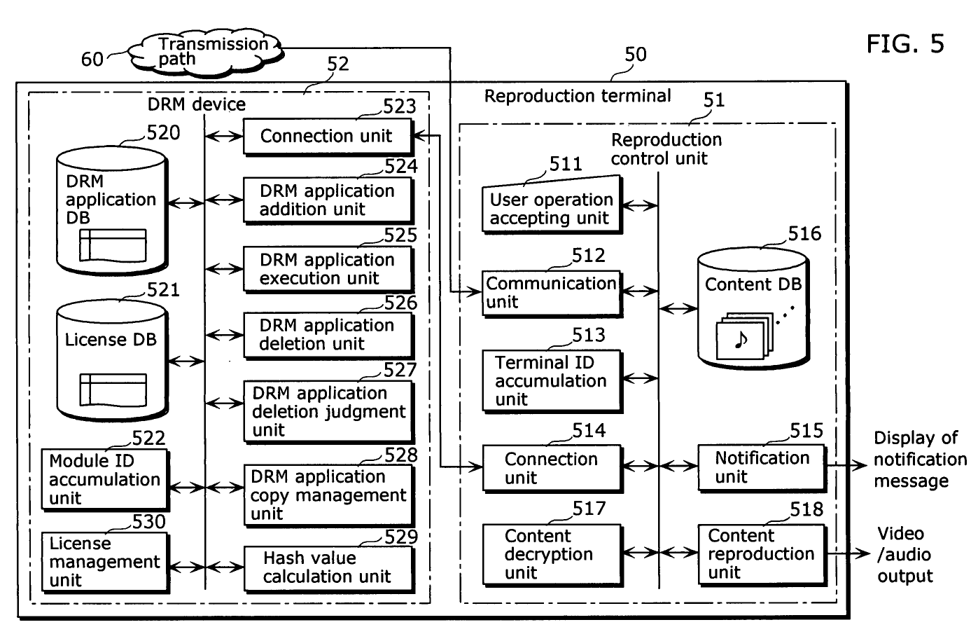

FIG. 5 is a functional block diagram showing a detailed structure of the reproduction terminals 50a, 50b, 50c, or . . . shown in FIG. 1. In FIG. 5, the functional structure of the reproduction terminal 50a is depicted as a representative of the reproduction terminals 50a, 50b, 50c, . . . , and is illustrated as “Reproduction terminal 50”.

The reproduction control unit 51 of the reproduction terminal 50 includes a user operation accepting unit 511, a communication unit 512, a terminal ID accumulation unit 513, a connection unit 514, a notification unit 515, a content decryption unit 517, and a content reproduction unit 518, in addition to the above-described content DB 516.

The user operation accepting unit 511, which includes an input operation unit such as a keyboard, accepts input operations from the user such as a power-on operation, as well as an operation for downloading a content to be used, a license, and a DRM application.

The communication unit 512 communicates with the content distribution servers 10a, 10b, 10c, . . . , the license distribution servers 20a, 20b, 20c, . . . , the DRM application distribution servers 30a, 30b, 30c, . . . , and the system server 40.

The terminal ID accumulation unit 513 accumulates a terminal ID unique to the reproduction terminal 50, a public key certificate, a certificate revocation list (hereinafter also referred to as a “CRL”), or the like.

The connection unit 514 is a communication interface that enables a communication with the DRM device 52. The connection unit 514 performs mutual authentication with the DRM device 52, and securely receives a content key or the like after establishing such a secure communication path as the Secure Socket Layer (SSL) which is one of the SAC communication methods.

The notification unit 515 sends, to a display, a notification message sent from the content distribution servers 10a, 10b, 10c, the license distribution servers 20a, 20b, 20c, . . . , the DRM application distribution servers 30a, 30b, 30c, . . . , the system server 40, and the DRM device 52, so as to cause the display to display the notification message.

The content DB 516 stores an encrypted content obtained from the content distribution server 10a, 10b, 10c, or . . . .

The content decryption unit 517 decrypts the encrypted content with the content key passed from the DRM device 52.

The content reproduction unit 518 reproduces the decrypted content under the management of the DRM device 52.

The DRM device 52 includes a module ID accumulation unit 522, a connection unit 523, a DRM application addition unit 524, a DRM application execution unit 525, a DRM application deletion unit 526, a DRM application deletion judgment unit 527, a DRM application copy management unit 528, a hash value calculation unit 529, and a license management unit 530, in addition to the above-described DRM application DB 520 and license DB 521.

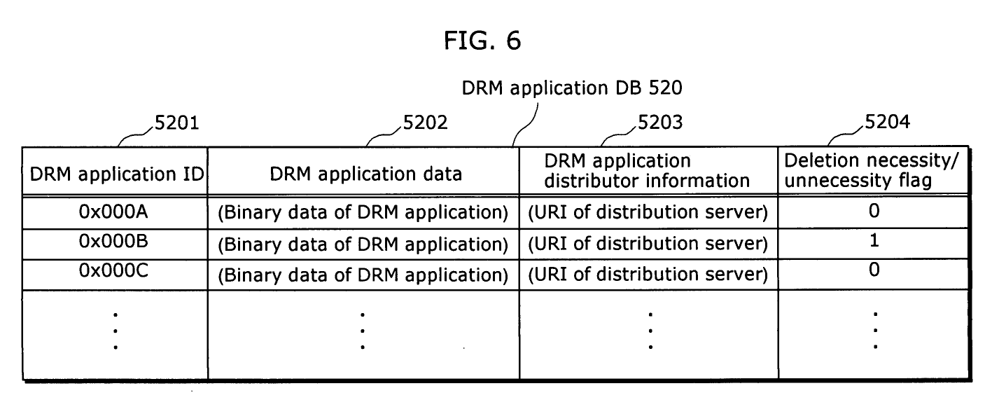

The DRM application DB 520 is a storage medium, or more specifically a memory, where DRM applications 90 distributed from the DRM application distribution servers 30a, 30b, 30c, . . . are stored and managed. Referring to FIG. 6, the DRM application DB 520 has a data structure that is made up of the following fields: a DRM application ID 5201 that indicates the identifier unique to a DRM application; DRM application data 5202 that is the main contents of such DRM application; DRM application distributor information 5203 that indicates the URI of a DRM application distribution server; and a deletion necessity/unnecessity flag 5204 indicating a result of a judgment made by the DRM application deletion judgment unit 527 of whether it is necessary to delete the DRM application or not. In the field of the deletion necessity/unnecessity flag 5204, “0” indicates that deletion is unnecessary, and “1” indicates that deletion is necessary.

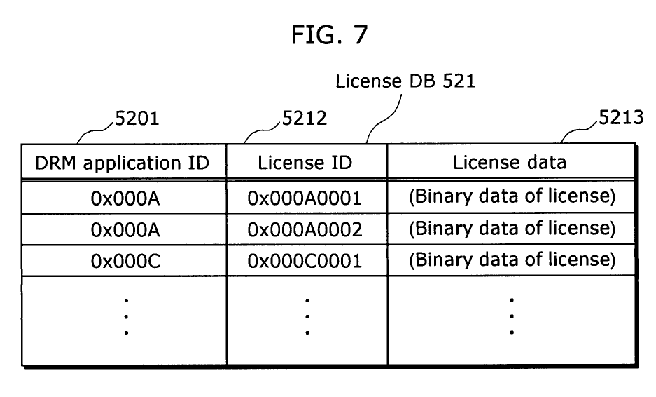

The license DB 521 is a storage medium, or more specifically a memory, where licenses 80 distributed from the license distribution servers 20a, 20b, 20c, . . . are stored and managed. Referring to FIG. 7, the license DB 521 has a data structure that is made up of the following fields: a DRM application ID 5201 that identifies a DRM application 90 for processing a license 80; a license ID 5212 that indicates the identifier unique to such license 80; and license data 5213 that is the main contents of such license 80, i.e., the binary data of the license 80.

The module ID accumulation unit 522 accumulates a public key certificate, a CRL or the like of the DRM device 52, in addition to the module ID unique to the DRM device 52.

The connection unit 523 is a communication interface that enables a communication with the reproduction control unit 51. The connection unit 523 performs mutual authentication with the reproduction control unit 51, the license distribution servers 20a, 20b, 20c, . . . , and the DRM application distribution servers 30a, 30b, 30c, . . . , as well as securely receiving the issued license and passing a content key, after establishing such a secure communication path as SSL which is one of the SAC communication methods.

The DRM application addition unit 524 (1) makes a request to the DRM device 52 of another reproduction terminal 50 asking for a copy of the DRM application 90 which such another reproduction terminal 50 holds, (2) receives the URI and the hash value of the DRM application that have been sent from the DRM device 52 of such another reproduction terminal 50, and (3) makes a request, to the DRM application distribution server 30a, 30b, 30c, or . . . identified by the received URI, asking for the download of a license 80.

The DRM application execution unit 525 is implemented by the CPU executing a DRM application read out from the DRM application DB 520. The DRM application execution unit 525 interprets and updates the usage rule(s) included in a license, and deletes a license. More specifically, the DRM application execution unit 525 searches the license DB 521 for the license corresponding to a content or for a license specified by the user, identifies the rights management method of the license, and identifies the usage rule(s) corresponding to the identified rights management method. The DRM application execution unit 525 also has the functions of reading the usage rule(s) from the license and judging whether the use of the content is permitted or not, and of passing the content key described in the license to the content decryption unit 517. Furthermore, the DRM application execution unit 525 passes, to the content reproduction unit 518, the content decrypted by the content decryption unit 517 so as to cause the content reproduction unit 518 to reproduce the content. Moreover, the DRM application execution unit 525 deletes a license from the license DB 521 in the case where the number of uses of the content has reached the number of uses defined by the usage rules and where the use expiration date defined by the usage rules has expired, i.e., when the use right has been exhausted.

The DRM application deletion judgment unit 527 judges, at predetermined timings, whether or not it is necessary to delete a DRM application stored in the DRM application DB 520.

The DRM application deletion unit 526 deletes, from the DRM application DB 520, a DRM application whose deletion is judged as being necessary by the DRM application deletion judgment unit 527.

The DRM application copy management unit 528, in the case where it receives a copy request from the DRM device 52 of another reproduction terminal 50 asking for a copy of a DRM application stored in the DRM application DB 520, sends, as a response, the URI and the hash value of the requested DRM application to the DRM device 52 of the requesting reproduction terminal 50.

The hash value calculation unit 529 calculates the hash value of the DRM application obtained from the DRM application distribution server 30a, 30b, 30c, or . . . , and calculates the hash value of the DRM application stored in the DRM application DB 520.

The license management unit 530 generates a license request message to the license distribution server 20a, 20b, 20c, or . . . , to ask for the obtainment of a license, and stores the obtained license into the license DB 521.

Note that the data storage units of the reproduction terminal 50 are each implemented as a storage medium such as a memory and an HDD, whereas the units other than the data storage units are each implemented as hardware such as an LSI or as a program or the like that is executed using a CPU, a RAM, and a ROM.

Furthermore, the above-described DRM application DB 520, DRM application deletion unit 526, and DRM application deletion judgment unit 527 make up an application management device 54. Such application management device 54 may further include a license DB 521, a license management unit 530, a notification unit 515, and a user operation accepting unit 511 depending on need.

The reproduction terminal 50 with the above structure is capable of using a content after downloading a license for using the content, downloading a DRM application for controlling the license, and then managing the license and the DRM application in association with each other. What is more, such reproduction terminal 50 is capable of supporting various rights management methods by adding necessary DRM applications one by one.

Meanwhile, in the case where a user installs an additional reproduction terminal 50, such user might wish to use a content by such added reproduction terminal 50 as s/he does by the reproduction terminal 50 which such user currently has. In such case, when the user moves a content and its license from the reproduction terminal 50 which s/he currently has (e.g., the reproduction terminal 50a) to the additionally installed reproduction terminal 50 (e.g., the reproduction terminal 50b), such user is required, as a prerequisite, to create the same environment in the DRM device 52 of the reproduction terminal 50b as that of the DRM device 52 of the reproduction terminal 50a. In other words, the user is required to store, into the DRM application DB 520 of the DRM device 52 of the reproduction terminal 50b, all the DRM applications that are the same as those stored in the DRM device 52 of the reproduction terminal 50a.

A conceivable way to create such an environment is to copy all the DRM applications from the DRM device 52 of the reproduction terminal 50a to the DRM device 52 of the reproduction terminal 50b. However, there is a possibility that there is a hacked DRM application in the DRM device 52 of the reproduction terminal 50a (hereinafter also referred to as a “secondary distributing device”), and it is no preferable to copy the DRM applications that include a hacked DRM application onto the DRM device 52 of the reproduction terminal 50b (hereinafter also referred to as a “secondary destination device”).

Another conceivable way to create the above environment in the secondary destination device as that of the secondary distributing device is to access the system server 40 so as to know the DRM application distribution servers 30a, 30b, 30c, . . . from which DRM applications are downloadable, and downloads the DRM applications from such DRM application distribution servers. However, this method involves complicated tasks such as checking the types of DRM applications stored in the secondary distributing device as well as looking up the URI of each DRM application distribution server 30a, 30b, 30c, . . . . Furthermore, it might happen with this method that a different DRM application is mistakenly downloaded from the DRM application distribution server 30a, 30b, 30c, or . . . .

In view of the above, the present embodiment has a structure in which: the secondary distributing device notifies the secondary destination device of the URIs and the hash values of the respective DRM application distribution servers; and the secondary destination device obtains the DRM applications from the notified servers, and checks whether these DRM applications match those stored in the secondary distributing device by checking whether the hash values of the obtained DRM applications and the hash values notified from the secondary distributing device match, and ensures that DRM applications obtained are not tampered by directly obtaining them from the DRM application distribution servers.

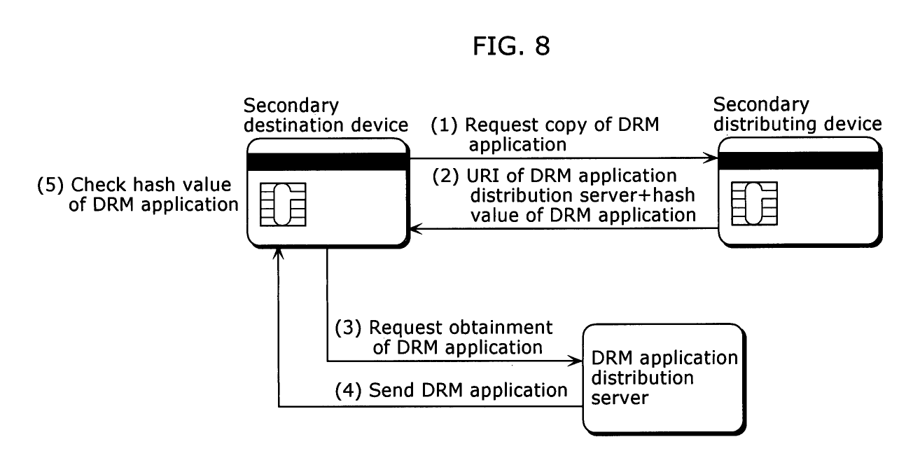

FIG. 8 is a diagram showing procedures for overall processing performed among the secondary distributing device, the secondary destination device, and the DRM application distribution server.

(1) The secondary destination device first makes a request to the secondary distributing device asking for all copies of the DRM applications.

(2) Upon receipt of the request for all copies, the secondary distributing device sends, to the secondary destination device, a list that describes the DRM application IDs of the respective DRM applications to be copied, the URIs that identify the servers distributing the respective DRM applications, and the hash values of the respective DRM applications.

(3) The secondary destination device makes an access to a server identified by an obtained URI and sends a DRM application obtainment request that includes the corresponding DRM application ID, so as to obtain a DRM application. This processing is repeated for all the DRM applications described on the obtained list.

(4) The DRM application distribution server which has received the request sends the DRM application to the secondary destination device.

(5) Upon receipt of the DRM application, the secondary destination device calculates the hash value of the received DRM application so as to check whether the calculated hash value match the hash value notified from the secondary distributing device, and stores the received DRM application into the DRM application DB 520 when they match.

Next, a detailed description is given of DRM application copying processing.

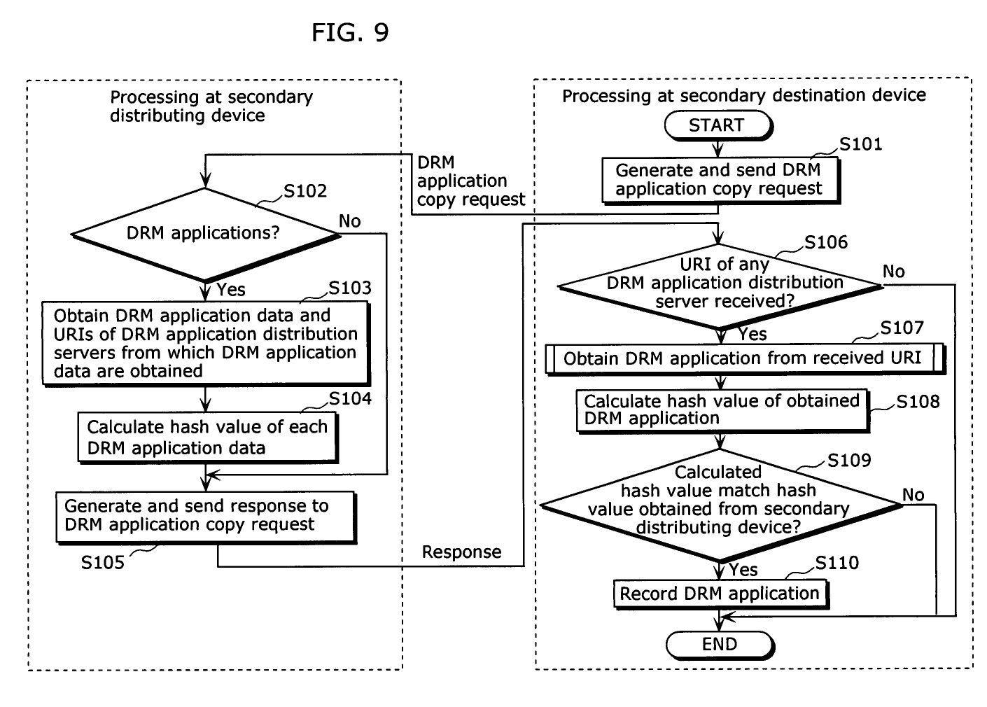

FIG. 9 is a flowchart showing details of DRM application copying processing. The following assumes that such processing is performed between the DRM device 52 of the reproduction terminal 50a and the DRM device 52 of the reproduction terminal 50b, i.e., between the secondary distributing device and the secondary destination device.

When the user operation accepting unit 511 of the secondary destination device receives a copy instruction from its user, the DRM application addition unit 524 of the secondary destination device generates and sends a DRM application copy request (S101).

The DRM application copy management unit 528 of the secondary distributing device judges whether there is any DRM applications in the DRM application DB 520 (S102). When there is/are DRM application(s) in the DRM application DB 520, the DRM application copy management unit 528 obtains all the DRM application data and the URIs of DRM application distribution servers from which such DRM applications are obtained (S103). Then the hash value calculation unit 529 calculates the hash value of each of all the DRM application data obtained by the DRM application copy management unit 528 (S104). Then, the DRM application copy management unit 528 generates and sends a response (S105).

Here, in the case where there is/are DRM application(s) in the DRM application DB 520, the response includes the URIs of the respective DRM application distribution servers and the hash values of the respective DRM application data. Meanwhile, in the case where there is no DRM application in the DRM application DB 520, the response includes a message that there is no DRM application.

Upon receipt of the response, the DRM application addition unit 524 of the secondary destination device judges whether such response includes the URIs of the DRM application distribution servers 30a, 30b, 30c, . . . (S106). In the case where the response includes the URIs of the DRM application distribution servers 30a, 30b, 30c, . . . , the DRM application addition unit 524 performs DRM application obtainment processing with the DRM application distribution servers 30a, 30b, 30c, . . . identified by the respective URIs (S107).

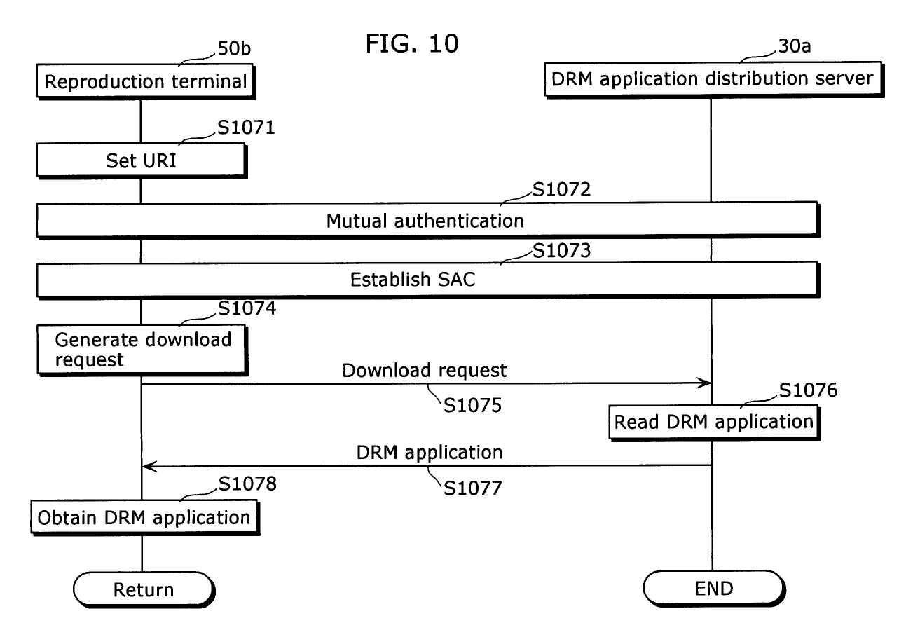

FIG. 10 is a diagram showing a sequence of the DRM application obtainment processing (S107) shown in FIG. 9. The following assumes that such processing is performed between the DRM device 52 (DRM application addition unit 524) of the reproduction terminal 50b and a DRM application distribution server identified by one of the URIs.

The DRM device 52 (DRM application addition unit 524) of the reproduction terminal 50b sets an URI included in the response (S1071). Note that the following assumes that such URI is the URI of the DRM application distribution server 30a.

When the URI is set, the connection unit 523 exchanges the public key certificates with the DRM application distribution server 30a identified by the URI, and performs mutual authentication (S1072). More specifically, the connection unit 523 verifies the validity of the party at the other end by checking the signature on the exchanged public key certificate and further checking whether the CRL lists the module ID of the DRM device 52 and the URI of the DRM application distribution server 30a. At the completion of the mutual authentication, the connection unit 523 establishes a SAC between itself and the DRM application distribution server 30a identified by the URI (S1072). More specifically, the connection unit 523 exchanges random numbers with the DRM application distribution server 30a, then mutually exchanges the digital signatures corresponding to the exchanged random numbers, generates a common session key based on the mutually exchanged random numbers and digital signatures, and performs a cipher communication using the generated session key.

After the establishment of the SAC, the DRM application addition unit 524 generates a download request (S1074), and sends the generated download request to the DRM application distribution server 30a (S1075).

Upon receipt of the download request, the DRM application distribution server 30a reads the requested DRM application from the hard disk or the like (S1076), and sends the readout DRM application to the reproduction terminal 50b (S1077).

In the above manner, the DRM application addition unit 524 obtains the necessary DRM application from the DRM application distribution server 30a (S1078), and returns to the main routine shown in FIG. 9.

The above description is given of the sequence carried out with the DRM application distribution server 30a identified by the URI, but in the case where the response includes plural URIs, the same sequence is carried out with the DRM application distribution servers identified by the respective URIs so as to download necessary DRM applications.

Upon obtaining the DRM application, the hash value calculation unit 529 calculates the hash value of the obtained DRM application (S108). After the hash value is calculated, the DRM application addition unit 524 judges whether or not the hash value calculated in Step S108 matches the hash value obtained from the secondary distributing device, i.e., the hash value notified from the DRM device 52 of the reproduction terminal 50a (S109).

In the case where these hash values match, the DRM application addition unit 524 records the DRM application into the DRM application DB 520 (S110), and ends the DRM application copying processing.

Meanwhile, in the case where these hash values do not match (No in S109), the DRM application addition unit 524 ends the DRM application copying processing without recording the DRM application into the DRM application DB 520. The DRM application addition unit 524 ends the DRM application copying processing also in the case where the URI of the DRM application distribution server from which the DRM application should be obtained is not received from the DRM device 52 of the reproduction terminal 50a (No in S106). Note that in the case where the hash values do not match, a message may be notified via the notification unit 515 warning that there is a possibility of hacking or the like. Furthermore, a message may be notified via the notification unit 515 indicating that the secondary distributing device does not store any DRM applications to be copied, also in the case where the URI of the DRM application distribution server from which the DRM application should be obtained is not received from the DRM device 52 of the reproduction terminal 50a.

Accordingly, it becomes possible to prevent such situations as where a hacked DRM application is copied onto the secondary destination device. What is more, it becomes not necessary to perform complicated tasks such as checking the types of DRM applications stored in the secondary distributing device as well as looking up the URI of each DRM application distribution server 30a, 30b, 30c, or . . . . Furthermore, it becomes possible to prevent the occurrence of such situations as where a different DRM application is mistakenly downloaded from the DRM application distribution server 30a, 30b, 30c, or . . . . Moreover, it becomes possible to prevent applications from being installed, even in the case where applications which were not hacked at the secondary distributing device are hacked in the DRM application distribution server 30a, 30b, 30c, . . . . Thus, it becomes possible to create the same environment in the secondary destination device as that of the secondary distributing device by using only authorized DRM applications that are guaranteed to be the same as those stored in the secondary distributing device.

Note that although hash values are used as data for verifying that DRM applications are the same as those stored in the secondary distributing device, it is also possible to use, as such data, the version of each DRM application, the year, month, and day on which each DRM application was created.

Next, a description is given of DRM application deletion processing performed by the reproduction terminal 50.

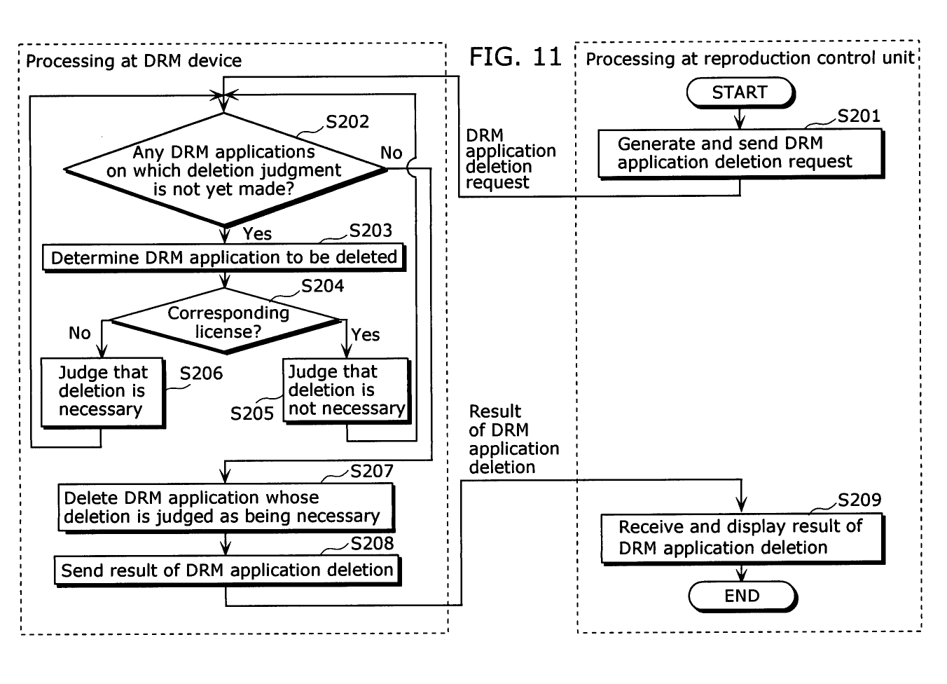

FIG. 11 is a flowchart showing DRM application deletion processing performed between the reproduction control unit 51 and the DRM device 52 of the reproduction terminal 50.

When the user performs a power-on operation and a DRM application downloading operation on the user operation accepting unit 511 of the reproduction control unit 51, the user operation accepting unit 511 generates a DRM application deletion request, and sends the generated request via the communication unit 512 (S201).

Upon receipt of the DRM application deletion request from the reproduction control unit 51 via the connection unit 523, the DRM application deletion judgment unit 527 of the DRM device 52 judges whether any DRM applications on which deletion judgment is not yet made is included in the DRM application DB 520 (S202). More specifically, the DRM application deletion judgment unit 527 searches the DRM application DB 520, and when the record of a DRM application (e.g., the record of 0x000A) is stored in the DRM application DB 520, judges whether such record is the last record or not.

In the case where there exits in the DRM application DB 520 a DRM application on which deletion judgment is not yet made, the DRM application deletion judgment unit 527 determines a DRM application on which deletion judgment should be made (S203), and judges whether or not the license corresponding to such determined DRM application is stored in the license DB 521 (S204). More specifically, the DRM application deletion judgment unit 527 determines the DRM application ID 5201 of the DRM application to be judged as “0x000A”, and then judges whether or not the license corresponding to this DRM application ID 5201 “0x000A” is stored in the license DB 521. In other words, the DRM application deletion judgment unit 527 judges the presence or absence of the license in the license DB 521, using the DRM application ID 5201 as a key.

When the judgment is that the license corresponding to the determined DRM application is stored in the license DB 521, the DRM application deletion judgment unit 527 judges that it is not necessary to delete such DRM application (S205), and returns to Step S202. Meanwhile, when the judgment is that the license corresponding to the determined DRM application is not stored in the license DB 521, the DRM application deletion judgment unit 527 judges that it is necessary to delete such DRM application (S206), and returns to Step S202.

More specifically, in the case where a DRM application that is associated with the DRM application ID 5201 is stored in the license DB 521, the DRM application deletion judgment unit 527 sets the deletion necessity/unnecessity flag 5204 to “0”, whereas in the case where such DRM application is not stored, the DRM application deletion judgment unit 527 sets the deletion necessity/unnecessity flag 5204 to “1”. Meanwhile, since it means that the license is stored in the license DB 521 in the case where the DRM application ID 5201 is “0x000A”, the DRM application deletion judgment unit 527 sets the deletion necessity/unnecessity flag 5204 to “0”.

The DRM application deletion judgment unit 527 repeatedly makes a judgment of whether application deletion is unnecessary (S205) or necessary (S206) for all DRM applications registered in the DRM application DB 520 on which deletion judgment is not yet made.

Accordingly, in the case where the DRM application ID 5201 is “0x000B”, the deletion necessity/unnecessity flag 5204 of this record is set to “1” since the license is not stored in the license DB 521, whereas in the case where the DRM application ID 5201 is “0x000C”, the deletion necessity/unnecessity flag 5204 of this record is set to “0” since the license is stored in the license DB 521.

When there becomes no DRM application in the DRM application DB 520 on which deletion judgment is not yet made, the DRM application deletion unit 526 deletes the DRM application whose deletion is judged as being necessary (S207), and sends the result of DRM application deletion to the reproduction control unit 51 via the connection unit 523 (S208). More specifically, the DRM application deletion judgment unit 527 deletes the second record in the license DB 521, i.e., the record of “DRM application ID “0x000B”, and sends an indication that the DRM application with the DRM application ID “0x000B” has been deleted.

Upon receipt of the result of DRM application deletion from the DRM device 52 via the connection unit 514, the notification unit 515 of the reproduction control unit 51 causes the display to display thereon such result of DRM application deletion (S209).

As described above, according to the application management device 54 of the present embodiment, it is possible to make a significant reduction in load since a judgment of whether deletion of an application is necessary or not is made based on fixed, invariant information and identification information (DRM application ID 5201) without using information about the free space which is time-variant information that changes momentarily, i.e., such judgment is made through extremely simple processing, which causes little load, of judging whether or not license data associated with identification information is in the license DB 521. What is more, since a free space is reserved in the DRM application DB 520 by deleting a DRM application whose deletion is judged as being necessary, it is possible to be ready for the download of a necessary DRM application.

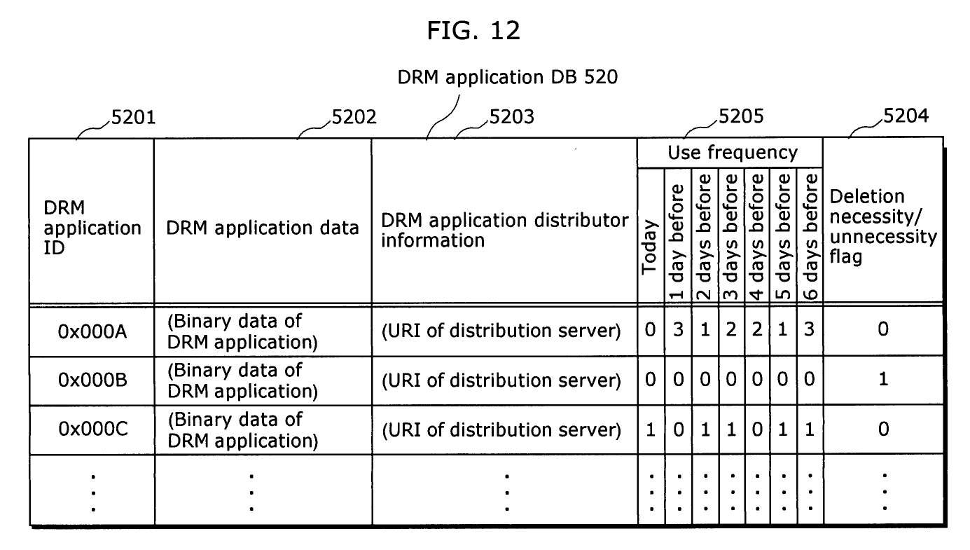

Note that in the above-described embodiment, although a DRM application whose corresponding license does not exist is judged as being necessary to be deleted, a DRM application whose use frequency is low may be judged as being necessary to be deleted. In this case, referring to FIG. 12, the DRM application DB 520 may include, for example, a field for use frequency 5205 for measuring the use frequency of a DRM application, and the number of uses in each day is incremented every time a DRM application is used. Accordingly, it is possible for the DRM application deletion judgment unit 527, at the time of DRM application deletion processing, to set the deletion necessity/unnecessity flag to “1” for the record of the DRM application whose use frequency is the lowest (in an example shown in FIG. 12, the DRM application ID 5201 “0x000B”).

Accordingly, a significant reduction is made in load since it is possible to make a judgment of whether deletion of an application is necessary or not through extremely simple processing of detecting an application with the lowest use frequency among applications that are associated with the DRM application IDs 5201.

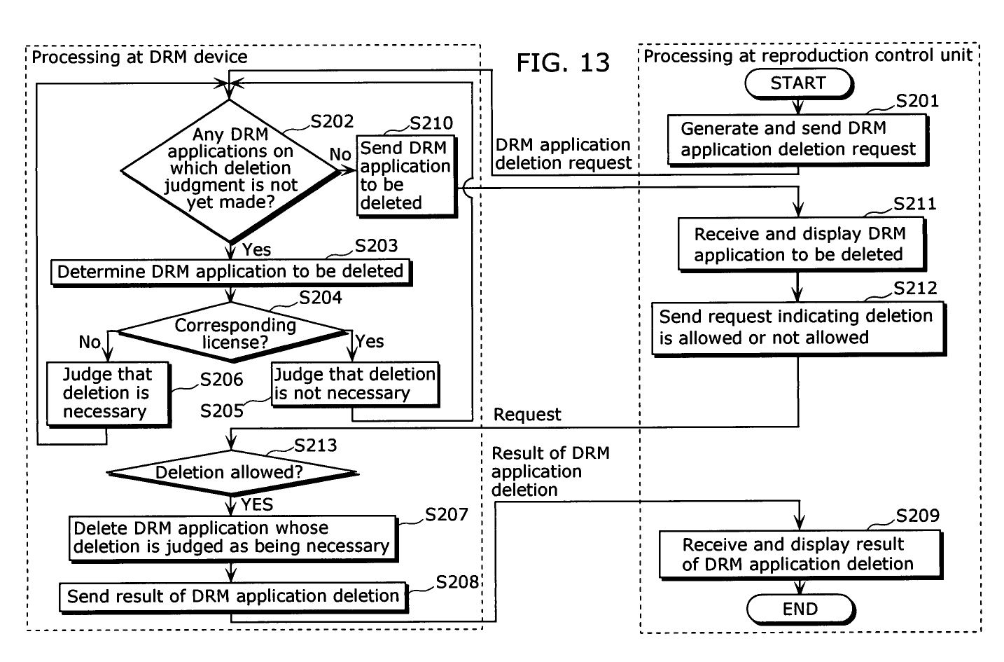

Furthermore, in the above-described embodiment, although the DRM application deletion unit 526 deletes a DRM application immediately after such DRM application is judged as being an unnecessary application, the DRM application deletion unit 526 may delete a DRM application to be deleted after it is allowed by the user to do so. In this case, referring to FIG. 13, Step S210 to Step S213 are added to the DRM application deletion processing. In other words, when there becomes no DRM application on which deletion judgment is not yet made (No in S202), the DRM application deletion unit 526 first sends information related to a DRM application to be deleted to the reproduction control unit 51 (S210) and waits for a request. The notification unit 515 of the reproduction control unit 51 receives such information related to the DRM application to be deleted and causes the display to display it (S211). The user operation accepting unit 511 generates a request indicating either that deletion is allowed or not allowed according to a user instruction, and sends the generated request (S212). The DRM application deletion unit 526 judges whether the request indicates that deletion is allowed or not (S213), and deletes the DRM application to be deleted (S207) when the request indicates that deletion is allowed (Yes in S213). Meanwhile, when the request indicates that deletion is not allowed (No in S213), the DRM application deletion unit 526 cancels the DRM application deletion processing, and sends a message that the deletion processing is cancelled to the reproduction control unit 51 via the connection unit 523.

Furthermore, in the above-described embodiment, although the DRM application deletion processing is started when the user operation accepting unit 511 accepts a power-on operation and a DRM application downloading operation, the DRM application deletion processing may be started when the license management unit 530 deletes an exhausted license from the license DB 521 by being triggered by such deletion, or when the user operation accepting unit 511 receives an instruction from the user indicating that the DRM application deletion processing should be started.

Moreover, in the above-described embodiment, although the DRM application ID 5201 is used as identification information, other information such as the license ID 5212 may be used as identification information. In this case, the DRM application DB 520 and the license DB 521 are required to be structured in accordance with such identification information.

Furthermore, in addition to the case where an application to be deleted is judged based solely on either the presence or absence of a license or the use frequency of an application, it is also possible, when there are plural applications whose deletion is judged as being necessary, to determine an application to be deleted by narrowing down to one application based on a combination of the presence or absence of a license and another criterion for deletion judgment (e.g., the last use date on which each application was used last, the use frequency of each application, the expiration date of each application) so as to delete such determined application. Accordingly, even when there are plural applications whose deletion is judged as being necessary, it is possible to delete an optimum application through extremely simple processing of narrowing down to one application based on a combination of the presence or absence of a license and another deletion criterion, and further to make a significant reduction in load.

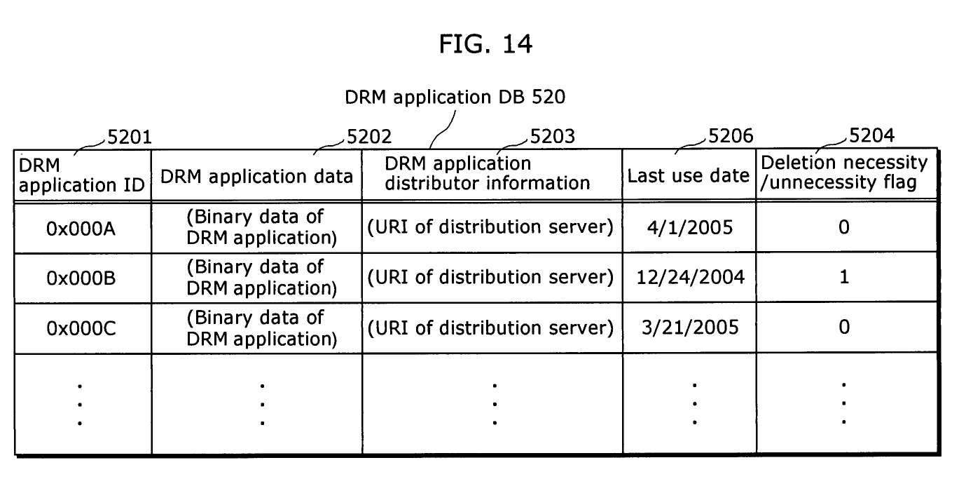

More specifically, in the case where the above-described another criterion for deletion judgment is the last use date, referring to FIG. 14, the DRM application DB 520 further includes a field for the last use date 5206, so that the last use date is managed in the DRM application DB 520 in association with its DRM application ID. Plural applications whose last use date is the oldest are then selected, and an application is deleted, from among the selected applications, starting from one whose corresponding license does not exist.

In the case where the above-described another criterion for deletion judgment is the use frequency, plural applications whose use frequency is low are selected, using the DRM application DB 520 shown in FIG. 12, and an application is deleted, from among the selected applications, starting from one whose corresponding license does not exist.

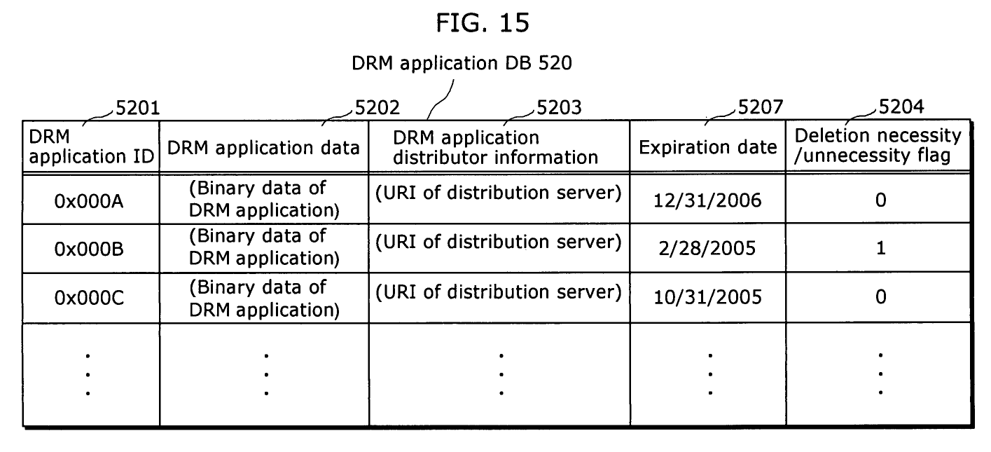

In the case where the above-described another criterion for deletion judgment is the expiration date, referring to FIG. 15, the DRM application DB 520 further includes a field for the expiration date 5207, so that the expiration date is managed in the DRM application DB 520 in association with its DRM application ID. Plural applications whose expiration date has expired are then selected, and an application is deleted, from among the selected applications, starting from one whose corresponding license does not exist.

Furthermore, it is also possible to use at least two of the last use date, the use frequency, and the expiration date of each application as other criteria for deletion judgment and to manage such at least two criteria in the DRM application DB 520 in association with the corresponding DRM application ID. In this case, plural applications to be deleted are selected based on such combination of plural criteria for deletion judgment, and an application is deleted, from among the selected applications, starting from one whose corresponding license does not exist.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The application management device according to the present invention is applicable to a content reproduction device, a PC, a personal digital assistant (PDA), a mobile phone, an STB, or the like that uses a variety of digital contents, protecting their copyright, in an environment that includes a mixture of plural rights management methods, and is suited for use as an application management device that manages an application that is a program for processing a license corresponding to a content.

1. An application management device that manages applications, each of which is a program for processing a license corresponding to a content, said device comprising:
an application storage unit operable to hold the applications, each of which is associated with identification information that identifies a correspondence between a license and the application for processing the license; and
an application deletion judgment unit operable to judge, for each of the applications held by said application storage unit, whether deletion of an application is necessary or not, based on the identification information.

2. The application management device according to claim 1, further comprising
an application deletion unit operable to delete an application whose deletion is judged as being necessary by said application deletion judgment unit.

3. The application management device according to claim 2, further comprising
a first presentation unit operable to present, to a user, the application deleted by said application deletion unit.

4. The application management device according to claim 3, further comprising
a second presentation unit operable to present, to the user, the application whose deletion is judged as being necessary by said application deletion judgment unit,
wherein said application deletion unit is operable to delete the application after receiving, from the user, an instruction to delete the application.

5. The application management device according to claim 1, further comprising:
a license storage unit operable to hold each license in association with the identification information; and
a license deletion unit operable to delete, from said license storage unit, a license whose use right has been exhausted,
wherein said application deletion judgment unit is operable to judge whether deletion of an application is necessary or not by being triggered by the deletion of the license performed by said license deletion unit.

6. The application management device according to claim 1,
wherein said application deletion judgment unit is operable to judge whether deletion of an application is necessary or not by being triggered by at least one of the following operations performed by a user: a power-on operation and an operation for downloading an application.

7. The application management device according to claim 1,
wherein the identification information is at least one of an application ID unique to each application and a license ID unique to each license.

8. The application management device according to claim 1, further comprising
a license storage unit operable to hold each license in association with the identification information,
wherein said application deletion judgment unit is operable to judge that deletion of an application is necessary, the application being an application whose license associated with the identification information is not held by said license storage unit.

9. The application management device according to claim 1,
wherein said application storage unit is operable to hold information showing a use frequency of each application in association with the identification information, and
said application deletion judgment unit is operable to judge that deletion of an application whose use frequency is lowest is necessary.

10. The application management device according to claim 1, further comprising
an application deletion unit operable to delete an application whose deletion is judged as being necessary by said application deletion judgment unit,
wherein said application storage unit is operable to hold, in association with the identification information, a first criterion for application deletion indicating presence or absence of each license and a second criterion for application deletion that is different from the first criterion,
said application deletion judgment unit, in the case of judging that deletion of a plurality of applications is necessary, is operable to determine an application to be deleted by narrowing down the plurality of applications to one application based on a combination of the first criterion and the second criterion, and
said application deletion unit is operable to delete the application determined by said application deletion judgment unit.

11. The application management device according to claim 10,
wherein the second criterion is a last use date that is a date on which each application was used last, and
said application deletion unit is operable to delete the plurality of applications starting from the application whose corresponding license is not present, the plurality of applications having an oldest last use date.

12. The application management device according to claim 10,
wherein the second criterion is a use frequency of each application, and
said application deletion unit is operable to delete the plurality of applications starting from the application whose corresponding license is not present, the plurality of applications having a lowest use frequency.

13. The application management device according to claim 10,
wherein the second criterion is an expiration date of each application, and
said application deletion unit is operable to delete the plurality of applications starting from the application whose corresponding license is not present, the plurality of applications having an expired expiration date.

14. An application management method for managing applications, each of which is a program for processing a license corresponding to a content, said method comprising:
storing the applications into an application storage unit, each of the applications being associated with identification information that identifies a correspondence between a license and the application for processing the license; and
judging, for each of the applications held by the application storage unit, whether deletion of an application is necessary or not, based on the identification information.

15. A program for managing applications, each of which is a program for processing a license corresponding to a content, said program causing a computer to execute:
storing the applications into an application storage unit, each of the applications being associated with identification information that identifies a correspondence between a license and the application for processing the license; and
judging, for each of the applications held by the application storage unit, whether deletion of an application is necessary or not, based on the identification information.

16. A computer-readable storage medium storing a program for managing applications, each of which is a program for processing a license corresponding to a content, the program causing a computer to execute:
storing the applications into an application storage unit, each of the applications being associated with identification information that identifies a correspondence between a license and the application for processing the license; and
judging, for each of the applications held by the application storage unit, whether deletion of an application is necessary or not, based on the identification information.
